(19) United States
(12) Patent Application Publication
(10) Pub. No.: US 2010/0209698 A1
(43) Pub. Date: Aug. 19, 2010

(54) OPTICALLY/THERMALLY WRITABLE NANOCOATING

(76) Inventors: Andreas Kornherr, Wien (AT); Thomas Schalkhammer, Kasten (AT)

Correspondence Address: WENDEROTH, LIND & PONACK, L.L.P., 1030 15th Street, N.W.,, Suite 400 East, Washington, DC, 20005-1503, US

(21) Appl. No.: 12/733,325

(22) PCT Filed: Aug. 21, 2008
(86) PCT No.: PCT/EP2008/006866

§ 371 Date: Apr. 16, 2010

(30) Foreign Application Priority Data
Aug. 25, 2007 (EP) 07016702.8

(51) Int. Cl. B32B 5/16; B32B 5/00; B32B 15/00; B32B 29/00; B32B 18/00; B32B 15/02; B05D 1/36; B05D 1/12; B05D 5/00

(52) U.S. Cl. 428/323; 428/403; 428/457; 428/537.5; 428/446; 427/404; 427/180; 427/554; 427/197

(57) ABSTRACT

A novel method, and the writing system used, for writing on surfaces with a coloured inscription are proposed, characterized in that a number of thin layers each of less than 800 nm are applied on or in a material (1, 2), wherein a layer or layer interface at least partially reflects electromagnetic waves (3), a transparent layer (4) with a thickness of less than 700 nanometres is provided above and/or below this reflective layer and on top of that there is at least one layer of metallic or at least strongly chromophoric particles (5), with a mass thickness of less than 50 nm, or alternatively the chemical precursors of such particles or alternatively a metallic thin film of less than 50 nm thickness, and the entire structure is changed in its colour in a spatially defined and structured manner by exposure to light or by direct contact with or close proximity to hot objects, wherein any desired text, design or graphic information (6) becomes visible as a result of changing the structure of the nanolayers, at least some of the colours being brought about by a resonance colour dependent on the thickness and the refractive index of the layer (4).

The invention relates to a novel method for color-imparting inscription of the surfaces of paper, films, plastic, metal, ceramic surfaces, artificial and natural stones, paint coats or corrosion protection layers.

Color-imparting inscriptions on materials such as paper, films, plastics or other surfaces are generally effected by printing, for example by means of known inkjet printers, laser printers and the like.

For this purpose, the printer is equipped with printing ink cartridges or toner cartridges, and the pigment compositions present therein are deposited during printing on the material to be imprinted.

EP 677 738 A1 discloses an optochemical sensor for measuring material concentrations with a reactive sensor layer, which is characterized in that a reflective layer (2), a reactive, in particular swellable matrix (4) and a layer (3) comprising a plurality of islands (5) of electrically conductive material, in particular metal, is provided, the diameter of the islands (5) being smaller than the wavelength of the light used for viewing or evaluation.

AT 407165 B1 discloses colored metal sheets, metal parts and metalized surfaces on whose surface a thin layer of less than 1000 nm is applied by an anodizing method, which thin layer carries on the surface a layer of metallic or chromophoric particles having a size of less than 200 nm which generate visible color effects by surface-amplified cluster absorption.

JP 59-126468 describes, for example, lamellar pigments which are based on mica substrates and are coated with a layer of titanium dioxide and titanium suboxides and/or titanium nitrides.

JP 60-60163 describes lamellar pigments which are based on mica substrates and which are coated with a first layer of titanium suboxides or titanium nitrides and covered with a second layer of titanium dioxide.

JP 3052945, JP 3052943, JP 3052944, JP 3059065, JP 3059062 and JP 3059064 disclose epoxy resin compositions which are laser-imprintable.

WO 93/19131 describes a process for the preparation of lamellar colored pigments, in which lamellar substrates coated with titanium dioxide are reduced with a selected reducing agent in solid form in a non-oxidizing gas atmosphere at elevated temperature. The body color achievable here ranges from grey to yellowish black and bluish black to black, it being possible to vary the interference color by varying the titanium oxide layer thicknesses.

Pigments which use a highly refracting layer as a basis are known, for example, by the name Iriodin®. These are multilayer interference pigments comprising layers of different refractive indices.

It is an object of the invention to provide a material which can be provided with information, such as characters, character chains, lines, symbols, images and the like, without use of toner pigment-containing print media.

A further object of the invention was to provide a method for producing such materials.

The invention therefore relates to paper, board, corrugated cardboard, pigment particles, films, injection molded or compression molded plastics parts, metal, ceramic surfaces, paint coats or corrosion protection layers coated with a plurality of thin layers, the material itself or a first layer being a reflective layer which itself at least partly reflects electromagnetic waves (3) or does so at the layer boundary, a second transparent layer (4) being applied above and/or below this reflective layer, and at least one third layer of metallic or strongly chromophoric particles or nanoparticles (5) or the chemical precursors thereof or a thin metallic film being applied on this transparent layer, and the entire structure being able to be changed in its color in a spatially defined and structured manner so as to be detectable by the human eye by the action of light or by direct contact with or close approach to hot objects.

The invention furthermore relates to a method for color-imparting inscription of materials, characterized in that a plurality of thin layers are applied on or in the material (1, 2), the material or a first layer being a reflective layer which at least partly reflects electromagnetic waves (3) itself or does so at the layer boundary, a transparent layer (4) being applied above and/or below this reflective layer, and at least one layer of metallic or strongly chromophoric particles (5) or the chemical precursors thereof or a thin metallic film being applied to this transparent layer and the entire structure being changed in its color in a spatially defined and structured manner so as to be detectable by the human eye by the action of light or by direct contact with or close approach to hot objects.

The invention furthermore relates to a method for producing optically thermally writable materials, such as paper, board, corrugated cardboard, pigment particles, films, injection molded or compression molded plastics parts, metal, ceramic surfaces, paint coats or corrosion protection layers, characterized in that a plurality of thin layers are applied on or in the material (1, 2), the material or a layer being a reflective layer which at least partly reflects electromagnetic waves (3) itself or at the layer boundary, a transparent layer (4) being applied above and/or below this reflective layer, and at least one layer of metallic or strongly chromophoric particles or nanoparticles (5) or the chemical precursors thereof or a thin metallic film being applied on this transparent layer.

A plurality of thin films of preferably less than 800 nm, particularly preferably less than 500 nm, thickness are applied on the surface of the material, in particular of a support material, a layer or layer boundary being capable of at least partly reflecting electromagnetic waves (reflective layer). A nanometrically thin spacer layer having a thickness of preferably less than 800 nanometers is mounted above and/or below this reflective layer. A further layer is formed by metallic or at least strongly chromophoric particles or the chemical precursors thereof or by a thin metallic layer of less than 50 nm thickness.

The multilayer structure is applied either directly to the surface of the support material or to generally lamellar pigments which in turn may be bound on a surface to the support material.

This structure can optionally be covered with a known protective film and/or with a layer having light-scattering properties. This light-scattering layer contains, for example, light-scattering particles, for example latex particles, which have a back-scattered light color from white to whitish and becomes transparent by melting of the particles to form a layer.

Paper, board, corrugated cardboard, pigment particles, films, injection molded or compression molded plastics parts, metals, ceramic surfaces, paint coats or corrosion protection layers are suitable as support material.

The reflective layer is preferably a metallic layer or a layer of strongly chromophoric particles selected from the group consisting of silver, gold, palladium, platinum, copper, indium, aluminum, nickel, chromium, vanadium, molybdenum, tungsten, titanium, niobium, tantalum, zirconium, tin, germanium, bismuth, antimony or silicon, or from another conductive material or the compounds, alloys or precursors thereof.

The transparent nanometrically thin spacer layer preferably consists of a layer of calcium fluoride, magnesium fluoride, barium fluoride or quartz or of polymeric layers. The pores of a porous or foam-like polymeric intermediate layer can be filled with a gas, preferably with air.

The third layer comprising metallic or strongly chromophoric particles preferably consists of elements or compounds selected from the group consisting of silver, gold, palladium, platinum, copper, indium, aluminum, nickel, chromium, vanadium, molybdenum, tungsten, titanium, niobium, tantalum, zirconium, tin, germanium, bismuth, antimony or silicon or from another conductive material or the compounds, alloys or precursors thereof.

Compounds are understood in each case as meaning chiefly metal salts, such as oxalates, carbonates, formates, acetates, hydroxides, phosphates or hypophosphites. If metal salts are used, reducing agents or oxidizing agents may furthermore be added to the metal salts.

Suitable reducing agents are salts of formic acid, oxalic acid, reducing nitrogen-hydrogen compounds, such as hydrazines, or inorganic reducing agents, such as tin(II) salts, hypophosphites, dithionites or borane compounds.

Suitable oxidizing agents are peroxides, percarbonates, perborates, nitrates, chlorates, perchlorates or analogous bromine compounds.

These additives are therefore preferably laser-activatable.

Nanoparticles or lower oxides of the metal compounds are then produced under the action of heat or light (preferably laser light).

The entire structure is changed in its color in a spatially defined and structured manner by the action of light, primarily laser light or another light source of sufficient strength, or by direct contact with or close approach to hot objects, any desired characters, letters, character chains, patterns, lines, images, symbols, designs or graphic information becoming visible as a result of a change in the structure of the nanolayers or the ordering or reordering of the nanoparticles or of a part of the particles.

The number of metallic or strongly chromophoric particles can be achieved by thermal change or resolution of the metallic particles, preferably with the aid of high-energy laser light, to give colorless products, preferably by solid and laser-liquefiable acids or alkalis or laser-activatable oxidizing agents in the layer.

The layers may also have laser light-absorbing additives, the additives preferably being molecules containing carboxyl groups.

The ordering or reordering of the coated particles or of a part of the particles can also be effected in particular by thermal or mechanical changing of the layers, such as, for example, embossing.

The multilayer structure (which consists preferably of at least 3 layers) produces a strong coloration of the object as a result of optical resonance amplification of the nanoparticle absorption with the phase boundary or mirror reflecting electromagnetic waves or a layer of material (⅔) having a sufficiently high refractive index, the optical 2-dimensional coloring/structuring of the material being achieved with laser light or another local heat source.

In the structure according to the invention, the resulting color is dependent on the distance of the metal particles from the phase boundary and on the refractive index of the materials and not on the intrinsic color of the particles, in contrast to pigment colors.

Unlike any coloration based on interference, this effect occurs only in the presence of generally metallic nanoparticles on many relatively thin, nanometric layers, and is evident only in the case of strongly light-absorbing particles.

The invention is based on a novel printing system which makes materials inscribable directly by means of heat and/or light (preferably laser light).

In contrast to laser printing or inkjet printing or similar printing processes, the color or the precursor thereof is already integrated here as a nanolayer in the material and is changed only locally in a targeted manner by the laser light.

The laser inscription of films, paper, natural stones, tiles, ceramic, enameled surfaces, passivated anodized or painted metals or metals provided with transparent coatings with the use of nanoparticles and nanometric thin layers with which in particular the coloring of surfaces, facades, ceramic in the sanitary and exterior sector, jewelry articles, but also bodywork metal sheets or elements in the decoration sector can be achieved in an optimum manner differs from customary pigment-based colorings through a multiplicity of properties.
adjustable hue
all colors with the same chemistry
stable to fading as a result of light
little use of material (only nanometer-thick layer compared with micron-thick pigment layers)
smart metallic appearance—if desired
low toxicity (because of little use of material and large choice of chemicals which can be used)
visible and invisible elements combined (primarily in the IR range of the spectrum)
machine-readable
extreme thermal stability
combinable with barcode and label technology
integration of elements which react to an external stimulus, such as temperature or moisture, with a color change.

The use of products exposed to light every day, such as printed products, paper or films in the outdoor area, can also be regarded as an important field of use of the novel product owing to the bleach-fast coloration.

What is important is that the substrate material itself produces the optical effect by the local change in the multilayer structure (also referred to as resonant layer) by the action of laser light or local heat and there is no need to apply any pigments (as in the case of a laser, inkjet or thermal transfer printer) for this purpose and this leads to colors having optical 2D/3D microstructures.

In a typical use, the binding, the separation or the production of generally metallic particles, especially nanoparticles, can be used for imparting color.

A change in the thickness of the spacer layer is also converted by the resonance amplification of the nanoparticles with the structured refractive index layers into an easily visible optical signal.

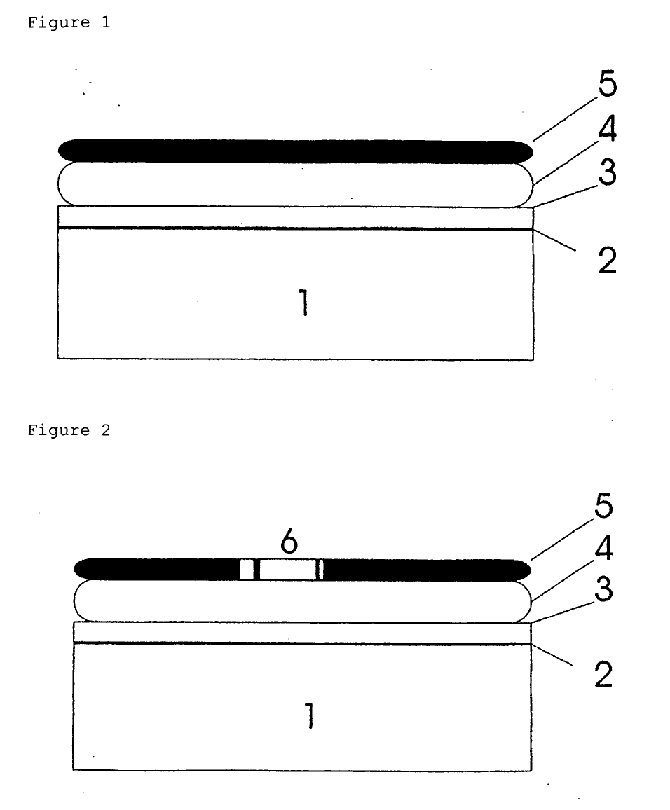

FIGS. 1 to 4 show the constructions according to the invention. There, 1 is the material, 2 is the surface of the material, 3 is the thin layer(s), 4 is the spacer layer, 5 is the metallic or strongly chromophoric particles or the chemical precursors thereof, 6 is the optical information (characters, character chains, symbols, figures, lines, images).

The construction consists at least of the at least partly light-reflecting surface of a support material, a spacer layer, a particle layer and optionally a covering layer.

In order to obtain clear coloring, the diameter of the nanoparticles is preferably chosen to be less than 50 nm, particularly preferably less than 40 nm.

For broad-band absorption, larger and asymmetrical particles may also be used.

A thin, substantially more or less continuous metal film of less than 40 nm thickness can be used instead of the particle layer.

A change in the occupation density of the particle layer on the molecular scale or changes in the spatial arrangement of the bound nanoparticles on the material leads to the characteristic changes in the optical appearance of the surface.

Metallic or metal-like particle films having a mean nanoparticle diameter of less than 500 nm (preferably less than 100 nm, particularly preferably less than 40 nm) have pronounced narrow-band reflection minima, the spectral positions of which are extremely sensitive to the spatial arrangement, in particular the distance to phase boundaries. (Very large particles scatter more than they absorb.)

The structure can convert even very small changes in the surface occupation with nanoparticles, in the structure of the material/thin layer phase boundary or in the refractive indices into clearly detectable color changes, i.e. either into a change in extinction at a certain wavelength or into a spectral shift of the absorption maximum.

In the context of the structure, a particular effect can be observed here. While the absorption of chromophores is independent of the angle of observation, the spectral reflection minimum of resonant layers shifts to a greater or lesser extent with the angle of observation. An article coated according to the invention therefore changes its color as a function of the angle of observation. Depending on the structure, this can be kept desiredly or, by the adequate choice of the components, virtually invisibly small.

According to the invention, primarily nanoparticles or extremely thin nanolayers are produced, changed or destroyed.

According to the invention, a reflective layer or only a reflecting surface, a spacer layer of a few tens (not more than a few hundreds of nanometers) nanometers and thereon metallic or chromophoric layers of preferably a few nanometers having a mass thickness of 1-20 nm are used.

Only in this way, for example, can the laser change the layer chemically throughout and permanently in the available time (typically μs or less) so that the resonance color is visually changed. “Massive” layers in the region of 50 nm or more led to pronounced intrinsic heating of the materials, which, for example in the case of paper, leads to a “burnt inscription” with a corresponding amount of waste gas and toxicologically unsafe products.

According to the invention, the printing system can avoid these problems by using strongly chromophoric resonator structures and can permit the writing process in the office environment by chemical conversion of parts of the structure without significant release of gaseous products. In addition to the change in thickness of the resonator, the resolution of the particles and the change in the mirror, the generation of nanoparticles from colorless precursors is preferably chosen.

The generation of the nanoparticles then first produces a resonance hue in situ after reaction of a colorless or faintly colored layer of precursor compounds.

The conversion of silver acetate into dark oxidic pigments, the conversion of bismuth salts, such as, for example, bismuth oxalate, basic bismuth carbonate or basic bismuth nitrate, into black, yellow, orange or brown pigments, the conversion of nickel oxalate or cobalt oxalate into black or dark-colored oxides, the conversion of labile copper compounds into copper oxides or metallic copper, may be mentioned here by way of example.

The transparent layer, in particular its thickness, can be adjusted by thermal change, foaming, crosslinking or thermal collapse, preferably with the aid of a laser or thermally.

All these reactions take place at temperatures of below 400° C., preferably about 250° C.

Extremely reactive compounds which show a chemical conversion at as low as 120° C. or less are not primarily used since they would adversely affect the required long-term stability and processible of the materials.

The resonance layer can be applied directly to stable surfaces; paper and large, in particular 3-dimensional objects are covered here with small particles having the structure described above.

These particles to which the multilayer structure is applied preferably have a size of not more than 3 mm, particularly preferably from 0.5 to 60 μm, and are preferably flat metallic particles or inorganic lamellae, such as mica, kaolin, talc or glass.

Paper can, however, also be provided directly with the color effect and the cellulose fiber-calcium carbonate mixture can be covered with mirror, spacer layer and nanoparticle layer—the observed colors are all very intense and have high color intensity.

With the use of particles as a support of the multilayer structure, the paper coating methods customary in the paper industry, in particular the last paper coating steps, are used for application to paper, corrugated board or cardboard. Such paper coating methods are known from the prior art and are familiar to the person skilled in the art.

Independently of the support material, it is advantageous to bind the particles to the surface of the coated material with an adhesion agent, for example with a starch-based adhesive or an adhesive based on biologically compatible and/or degradable polymers. Such adhesion agents are known to the person skilled in the art from the prior art.

The subsequent coating of the surface is effected with a material which is capable of absorbing the laser energy, transmitting the heat to the nanoparticle layer or the precursor thereof and protecting the entire structure. At a wavelength of the laser used, for example of 10 μm, this layer should be a few microns thick so that the laser energy can be absorbed with maximum intensity.

Many polymers are suitable for this purpose, for example PVP, PVAc, PVP-co-PVAc, cellulose and derivatives thereof, such as ethers or esters, starch and derivatives thereof, up to epoxy resins and alkyd resins for inscriptions having long-term stability on metal and plastics surfaces. Polystyrene, polyvinyl acetate, cellulose esters or ethers, other vinyl polymers, acrylates, methacrylates, polyalkyd resins or copolymers or mixtures thereof are preferably used, particularly preferably polystyrene latex.

The particle layers are either applied directly to the material or first formed on pigment particles by chemical processes, vapor deposition, sputtering, adsorptive deposition from solution, covalent coupling from solution, surface-catalyzed methods, spraying on or printing by means of known printing processes, such as flexographic, gravure, screen, offset or digital printing processes, cocurrent or countercurrent roll coating processes, curtain coating and the like.

The pigment particles are then transferred to the surface of the objects to be printed on in the application processes specific to the industry and are bound there.

The material of these particles are generally corrosion-stable metals, such as gold, silver, palladium, copper, nickel, chromium, tin, titanium, tantalum, niobium, tungsten, molybdenum, bismuth, antimony, germanium or silicon.

Other metals can be used to a limited extent for cost reasons or stability reasons (e.g. aluminum).

Less noble metals, protected from corrosion with an inert protective film comprising, for example, aluminum oxide, titanium oxide, zirconium oxide, tin oxide, quartz, firmly adhering oxidation films or polymers, layers of (poly)carboxylates, (poly)phosphates, (poly)phosphonates, can be used.

These protective layers do of course influence the color or the refractive index with the protective material film by their thickness.

Essentially any other metals and also alloys of all types or colored particles of suitable size and suitable (preferably generally stable) optical behavior (for example precipitates of porphyrins, phthalocyanines or the like) can also be used, with different color quality.

Preferably, the metals or metal salts used in the multilayer structure can be recovered in a wastewater treatment plant in a recycling process, preferably up to 80%.

According to the invention, all materials of the structure can be thermally-optically modified to achieve a printed image and thus either the mirror, the mirror-nanoparticle spacing or the number of nanoparticles above or below the spacer layer can be changed in order to achieve the desired color effects in the printing process.

The technological innovations according to the invention are:
color stable, papers, films and material surfaces imprinted so as not to fade
production and change of the color by local laser energy or heat transfer
freely selectable colors without pigments
assembled by means of nanometrically thin layers.

The light sources required for the thermal inscription preferably have a small beam divergence, small line/band width (a narrow line width is the frequency purity of the radiation produced), large energy density (due to the strong focusing and the self-amplification of the laser beams in the resonator) and large time-related and spatial coherence. Thus, primarily lasers are suitable as light sources. Other light sources can also be used after suitable optical preparation (LEDS, high-energy lamps with Hg, or metal vapor and the like) but generally have too low an energy density. Thermal initiation of the effect by hot surfaces is likewise possible and can be carried out analogously to thermal printing at low speed.

Possible laser types are solid-state lasers, semiconductor lasers, liquid lasers, gas lasers and chemical lasers. A distinction is made on the basis of the physical process: optically pumped lasers, gas discharge lasers and chemical lasers in which the pump energy is supplied by chemical processes.

The oldest known laser type comprises solid-state lasers, but they tend to show poor beam quality.

The most important solid-state lasers are the ruby, the neodymium-YAG (Nd:YAG) and the Nd:glass laser.

Semiconductor lasers, LEDs, krypton arc lamps and halogen lamps for cw operation and xenon flash lamps are particularly suitable for pulsed operation.

The copper vapor laser is the most well known member of a series of metal vapor lasers which have similar operating data (lead vapor laser, calcium vapor laser, gold vapor laser, manganese vapor laser, thallium vapor laser, indium vapor laser). Common to all these systems is that they have very high operating temperatures and can be operated only in pulsed mode but have very large amplification factors and in some cases also high efficiencies.

The advantages of semiconductor lasers are high efficiency, only a low DC voltage is required for operation, laser diodes are very small, very long lifetime (up to millions of operating hours) and laser diodes are suitable for continuous, semicontinuous and pulsed operation.

The laser group comprising the gas lasers is very large—a very wide range of gases are suitable for laser emission. These gases are introduced into gas discharge tubes having lengths of from 10 to 200 cm. These layers are pumped mainly by an electrical high-voltage discharge of the electrodes. The discharge currents may be from a few mA to 100 A. An example is, inter alia, the helium-neon laser. The ion laser uses a single gas, e.g. argon or krypton, as the active medium. The laser emission, however, originates here not from neutral but from ionized atoms. Of particular interest is the laser operating with triply ionized oxygen. In addition to some UV lines, there is a strong laser transition with yellow-green region at 559 nm. This line is distinguished in pulsed operation by a very high amplification.

The excimer laser derives its name from the English expression “excited dimer”, which means “excited two-atom molecule”. However, these molecules decompose as soon as excitation is no longer present and release their energy in the form of laser radiation. Compounds of noble gas atoms with halogen atoms, such as, for example, argon fluoride (ArF), krypton fluoride (KrF) and xenon fluoride (XeCl), are most frequently used for this laser type. Excimer lasers are powerful pulsed lasers having wavelengths in the UV or blue range of the spectrum. With their aid, cold cutting of human tissue can be achieved, i.e. cutting of tissue without it heating up.

A further laser is, for example, the CO laser.

The carbon dioxide laser (CO₂ laser) is an electrically excited gas laser. Together with the solid-state lasers, it is among the most frequently used and most powerful industrially employed lasers.

The N₂ molecules are excited in the resonator by a gas discharge. In this excited state, the N₂ molecules can persist for a very long time (˜1 ms) and there is therefore a high probability that they will collide with CO₂ molecules and excite them. Typical output powers are from 10 W to 15 kW. It is primarily used for material processing. The radiation of such CO₂ lasers is linearly polarized. Very high output powers and high efficiency are achieved with comparatively simple technology.

and, owing to their high refractive index, also a high reflection so that they can be used as output mirrors.

The helix TEA laser is a transversely excited CO₂ laser operating at high pressure.

The wavelength of the CO₂ laser is in the infrared range and therefore cannot be carried in glass fibers—in contrast to neodymium-YAG lasers or diode lasers.

The primary design of the nanowriter lasers comprises diffusion-cooled CO₂ lasers. They use a plasma discharge operated at high frequency between two closely adjacent plates which simultaneously produce cooling by diffusion. The beam path runs several times to and fro between the mirrors and the output coupling takes place at the shortened end of one of the mirrors. They are also often referred to as slab lasers. At small powers up to 300 W, the beam runs along to two elongated electrodes; in these lasers, no gas exchange takes place. In pulsed operation with short pulse times (0.01 . . . 1 μs), cooling and helium addition can be dispensed with at low powers. Such TEA-CO₂ lasers (from the English transversely excited atmospheric pressure) are fed, for example, by Marx generators and designed as a Blümlein generator. They are transversely excited and also operate at atmospheric pressure.

The CO₂ laser used in the power range of 500 W-15 kW and having flow in the longitudinal direction is very widely used. In the case of lasers “with slow flow”, only gas exchange occurs and the cooling takes place by diffusion at the tube walls. The gas mixture introduced into the tube system of lasers “having fast longitudinal flow” is circulated for gas exchange and cooling by means of a further pump (Roots pump or turbine). At very large powers, discharges and gas flow are transverse to the beam direction (CO₂ laser with transverse flow) so that particularly rapid gas exchange is possible. However, flow-through lasers cannot be expediently used as nanowriter lasers, owing to the required gas supply.

The nanowriter laser system preferably generally contains a sealed carbon dioxide (CO₂) laser which produces intense and invisible laser radiation having a wavelength of 10.6 micron in the infrared spectrum.

Since 1977, lasers have been classified according to the WHO regulation into 5 different protection classes:

Inter alia, the following safety features must be integrated into the system in order still to comply with the class 1 classification (laser light is harmless): The entire system is completely enclosed in a protective housing. This conceals the laser beam completely during normal use. The system has a safety cut-out system. Opening the housing causes the (CO₂) laser beam to switch off. Improper handling of the laser system is excluded by technical apparatuses since the laser beam can cause physical burns and serious eye damage. If a laser beam penetrates the eye, the maximum permissible temperature is exceeded and the visual cells (cones) arranged close together retract into the retina, where they are destroyed by the laser beam.

The laser beam may cause ignition of flammable materials and give rise to a fire. The laser system is therefore never operated without constant monitoring by internal sensors.

A correctly configured, installed, maintained and operable filter is the precondition for the use of the laser system. Vapors and smoke during the writing process are minimal since this is not an engraving process with process gases but the slight removal of material should, if necessary, be bound by an active carbon filter.

The use of materials unsuitable for the laser writer can produce toxic and pungent vapors.

Dangerous voltages are present within the electronic systems of laser units. Intervention in the machine is not necessary for normal use and is technically prevented. Safety stickers are mounted in the system. The safety sticker is visible only if the housing is forcibly opened. In addition, it is present on the laser tube, next to the laser outlet opening, and on the top of the tube. These stickers are visible only when the laser tube is exposed or removed and are not visible under normal operating conditions.

The room temperature should remain from 17 to 27 degrees Celsius.

The atmospheric humidity should be less than 70%.

The laser system is a single output unit—laser printer (a matrix-based output unit and also inkjet, bubble jet and dot matrix printer) or a plotter (“vector”-based output unit). The difference is in the manner in which characters and other graphics are formed. A mosaic printer performs forward and backward movements in order to create the character, while a vector plotter follows the contour of the character. A laser system performs both matrix and vector movements. The laser system printer driver operates directly together with Windows, Unix (Linux, . . . ) or similar application programs in order to send the correct image to the laser system.

The laser system is an output unit exactly like a printer or plotter. After the graphic has been created on the computer system, they print the graphic in the same way as you would print on a laser printer or a plotter. This information is sent via a cable (typically USB) to the laser system and is then stored in the laser system RAM. As soon as the user has loaded the file (completely or partly) into the memory, the processing can begin.

The only important difference between a typical laser printer and the nanowriter is that the laser system printer driver can additionally control the level of the laser energy.

The laser intensity can be controlled in a purely black-white manner or is controlled in such a way that a percentage of the intensity from 0 to 100% is assigned to each color used in the graphic drawing. Since the laser is proportionally pulsed or otherwise controlled in its intensity, this percentage represents the duration of the laser pulses or the level of the laser light intensity. In principle, the intensity setting is based directly on the depth of the color effect.

A speed setting via galvanomirror, rotating mirror and advance of the medium controls the speed at which the movement system operates relative to the maximum speed of the system. For example, if 100% speed is 100 centimeters, 10% speed is equal to 10 centimeters. During writing, this is the rate at which the laser beam moves over the medium. High intensity settings and high speeds produce similar effects to low intensity and slow speed—with a lower printing speed of the system. In the matrix mode, PPI (laser pulse/inch) often corresponds to the typical dpi values of a printer.

Low pulse values at very high energy lead to perforation of the paper—this is not desirable since toxic waste gases are formed here and require appropriate extraction.

In general, either rotating mirrors, Q switches or various types of galvanometers are used for deflecting the laser beam (open loop, closed loop galvanometer). The galvanometer receives a voltage from the computer—a short voltage peak results and very fast acceleration is effected. The position supplied by the sensor to the computer is now continuously compared. If the axis is at the desired point, the polarity at the galvanometer is rotated within a few nanoseconds, i.e. a short braking pulse is produced which brings the axis abruptly to a stop. Overshoots are ruled out and the circulation velocity is also substantially higher. The blanking of the laser beam can be effected with mirrors, Q switches or galvanometers—otherwise, only closed continuous lines or graphics could be produced with rotating mirrors or galvanometers. In order to blank out these pixels and lines, a further galvanometer, also referred to as shutter, is generally used. This galvanometer is positioned between the deflecting units and the laser. The computer then sends, when required, a signal to the shutter galvanometer, which pivots into the beam path of the laser and thus interrupts the beam. The laser beam must in order to be blanked out and inserted very rapidly by a blanking galvanometer.

The laser effect: nowadays, it is no longer possible to imagine doing without laser-assisted processing of a very wide range of materials since these tools have many advantages: laser beams can process fine, sharply defined areas. Laser devices have good, precise programmability, laser units have very good reproducibility, i.e. only very small tolerances, laser beams have no wear and are therefore very profitable, welding and soldering, utilizing in particular the property that only very small regions are heated for this purpose, cutting and drilling (with pulsed lasers) for diameters <0.5 mm, and laser inscription—very fast, with relatively little effort and with very good quality.

In physical terms, the interaction between radiation and material is divided into four categories: heating, melting, vaporization and ionization. Which of these categories is used depends both on the application (welding, soldering, cutting, drilling, inscription . . . ) and on the material. In order to obtain a clear contour of the marking, propagation of the heat influence zone must be prevented. This is achieved by a very high energy density, with the result that the material is heated within nanoseconds.

In the case of discoloration of plastics, marking is achieved without impairment of the surface quality by a local change of color. By a suitable choice of the plastic in combination with the wavelength of the laser light, a color change is produced on exposure to radiation. Depending on the choice of the materials, markings of different color can be produced by the method. Furthermore, it is also possible in the case of plastics to produce black/white by removal of material. For example, material layers opaque to light can be removed and the transparent base material exposed. As a result, markings which are recognizable through incidence of light from the front and illumination from the back can be produced. A further possibility is the heating of the plastic by the laser, resulting in a bulge. This bulge persists even after cooling and thus represents the marking. However, these high-temperature effects produce toxic waste gases and changes in the material and are undesired or unacceptable in office operation. The nanowriter can achieve the desired effects in nanothin layers without massive emission of ablation products.

Plastics can be processed with substantially lower powers than metals. A reason for this lies in the surface characteristics of the metals, which may have reflection values of from 90 to 100 percent in the bare state. Furthermore, thermal conductivity and melting point of the metal play a major role in material processing. The higher the melting point, the more difficult is the laser processing.

The laser type used for processing also depends on the diameter of the focal spot, which is focused by means of a suitable optical system in order to achieve greater power densities and possibilities for finer processing. He—Ne lasers can be focused to about 1 μm, Nd:YAG lasers to 5 μm and CO₂ lasers (which are also the most widely used laser group for material processing) can be focused to about 25 μm. The pulse duration must also be taken into account when choosing the laser since in particular drilling and cutting would not be possible without pulsed lasers (generally Nd:YAG lasers).

At high laser power, a vaporization region occurs in every case, adjacent to which are a melting zone and a heated zone. Depending on the application, only one workpiece is processed in a targeted manner with a pulsed or continuous laser of certain power and beam focusing.

The overall energy consumption of the system arises primarily only from the laser power plus waste heat, whereas the energy consumption of the advance is unimportant, and an additional fixing process of the toner with heat is not primarily envisaged but can be combined with the method as a secondary feature. The device therefore consumes energy primarily only in direct printing operation. Typical laser printers currently have standby powers of from about 5 to 30 watt and draw up to 1000 W power in printing operation. Here too, the nanowriter is substantially superior to existing printing processes owing to lower energy consumption and the lack of any heatup time to the first page.

With the increasing packaging of products and the associated product-specific marking, packaging perforation (tear-open, tear-off or separation aids) is increasing in importance. CO₂ laser radiation permits flexible, fast and exact perforation and cutting of a very wide range of materials without residues on the workpiece, such as, for example, thin plastics films and composite films, laminates, textiles and paper. This mode can be integrated as an additional option in the nanowriter.

According to the invention, all layers of the structure which contribute to the imparting of color can be used as reactive layers. Particular attention should be paid here to the interaction with the laser, in order to utilize the necessary energy optimally and hence to maximize the writing speed.

A CO₂ laser can be set to a wavelength of 10.6 μm (standard setting) or close to 9.6 μm. This wavelength is substantially better absorbed by silicates and similar structures (difference more than a power of ten). An Nd:YAG laser (1.06 μm) can likewise be used but requires the use of an additional chromophore for the targeted introduction of the laser energy. The transformation of a porous SiO₂ gel layer into a solid silicate layer with substantial reduction of the layer thickness (color effect) can therefore be produced, for example, with hot air, hot surfaces (stamp, pin) or laser energy of a CO₂ or Er:YAG or Ho:YAG (yttrium aluminum garnet) laser. In order to absorb laser energy optimally in a layer, from 0.1 to 5 percent by weight of a dye, preferably an inorganic salt, can be added to the material—possible chromophores here are copper salts, chromium salts or rare earth metals.

According to the invention, lasers having a power of up to 300 W can be used for normal office requirements. Higher laser powers are employed for industrial use, for example for inscription in manufacturing lines, for example for packagings or in large printing works.

Suitable apparatuses and writing systems corresponding to the above embodiments are defined in the claims.

The following examples describe the technical realization without limiting it:

### EXAMPLE 1

### Surface-Amplified Color Effect

A silver film of 45 nm thickness is first applied to a paper surface by sputtering. Thereafter, a quartz, magnesium fluoride, calcium fluoride or similar transparent layer is applied by vapor deposition in a high vacuum. The paper is freed from adhering water in a high vacuum (water content of up to 5% requires long prepumping times). Preheating of the paper can greatly shorten the pumping process. Thereafter, the desired material for layer (3), generally likewise silver, is thermally vaporized in a tungsten, molybdenum or tantalum boat or by means of an electron beam (if appropriate, also with AC plasma). The surface temperature of the paper should not be above 200° C., in order to avoid thermal decomposition of the paper matrix. The mass thickness of the silver layer applied by vapor deposition or sputter coating is typically from 3 to nanometers, the color impression shifting with increasing layer thickness from a broad-band spectrum through a sharp spectral band (or plurality of sharp spectral bands) toward the impression of metallic surfaces. In order to achieve optimum coloring, gold or silver can be coated, for example with 5 nm (mass thickness) within 10 sec at a current strength of about 10 mA/inch² and an argon pressure of 0.1 mbar. Often, an adhesion promoter is required for the gold layer. Gold can also be replaced by other corrosion-stable metals.

### EXAMPLE 2

### Colored Layer Effect on Films

Analogously to example 1, any thermally stable film can be used instead of paper. PET, PEN, PP or PE films are widely used industrially. In principle, however, any support material can be used. In particular, adhesion problems on some surfaces (e.g. PE or PP) necessitate pretreatment of the film by corona discharge, flame treatment, etching or plasma processes.

### EXAMPLE 3

### Color Effect on Material Having an Intermediate Layer with Relatively High Refractive Index

A layer of aluminum oxide, zirconium oxide, tin oxide, titanium oxide, niobium oxide or related materials, such as nitrides or oxynitrides, is applied to paper, film, metal sheet, pigment (e.g. mica) or a plastics surface by reactive vapor deposition in a high vacuum or reactive sputtering. Most oxides have efficient reflection of light at the phase boundary. Thereafter, the procedure is as in example 1, and a layer of materials having a low refractive index, e.g. magnesium fluoride, calcium fluoride or barium fluoride, is applied. The further procedure is analogous to that already described in example 1.

Reactive vaporization and sputtering (generally oxides, nitrides or oxynitrides) requires precise process gas control in order to ensure the required stoichiometry of the materials. In contrast to metals, the sputtering of pure nonconductors is possible only with special sputtering units, generally AC or DC pulse units, and with relatively high sputtering power. Nitrides or oxides generally sputter up to about 10 times more slowly than the corresponding metals.

### EXAMPLE 4

### Color Effect with Semitransparent Mirror

First, a non-impermeable particle layer or a very thin transparent layer of a metal having suitable adhesion and corrosion stability is applied to the material or pigment surface by chemical vapor deposition or by vapor deposition in a high vacuum or sputtering. Suitable metals here are, for example, gold (generally only with adhesion layer), silver (moderately stable and poorly adhering), palladium (stable but poorly adhering), preferably titanium, niobium, chromium, nickel, tin or the like. This is effected by sputtering or thermal or electron beam vaporization. The further construction is effected as described in example 1.

### EXAMPLE 5

### Other Application Techniques

In principle, in all applications described, the application of nanoparticles by coating or printing is also always possible according to the invention both as nanoparticle (4) and for change in the phase boundary properties of the material surface (2). Thereafter, the procedure is as described in example 1.

### EXAMPLE 6

### Color Layer on Coated Metal Surfaces

A commercially available stainless steel, brass or aluminum foil is structured analogously to example 1. In order to achieve optimum adhesion, the material is generally first coated with adhesion-promoting silanes. The silane is generally sprayed onto the oxide layer and baked at from 80° C. to 160° C. The silane layers are crosslinked in this procedure.

Nanoparticles can also be applied as metal colloids from a concentrated (>>100 mg of metal/l) and chemically or adsorptively bound. Colloidal solutions of lower concentration are generally unsuitable (owing to the long process time) for industrial processes. Colloids are generally used after protection with polymers or employed after covering with a 1-100 nm thick glass- or polymer-like layer. Particle-protecting polymers may be charged so that they bind with high affinity to the oppositely charged surface of the thin layer. Hydrophobic attraction forces can also advantageously be used here (thin layer (3) comprising plastics coat+gold/silver/copper nanoparticles covered with hydrophobic thiol monolayer).

### EXAMPLE 7

### Surface Protection with Coatings

Objects produced according to examples 1 to 6 are covered by spray coating, knife coating or immersion with a coat comprising starch solution, polyacrylates, polymethacrylates, polyurethanes or epoxy resin. The coat is dried and if necessary cured at elevated temperature. The exact curing conditions should be chosen according to the coat manufacturer's data. An object can also be covered with polymer solution by spray, spin or immersion methods, the solvent then removed and the film crosslinked by UV radiation (e.g. acrylates), electron beams or thermally.

### EXAMPLE 8

### Surface Protection in the Sol/Gel Process

Analogously, the objects are also covered with sol/gel coats and these are usually baked at temperatures of from 200 to 800° C. Typical raw materials here are metallates of titanium (e.g. titanium ethoxylates), tetraethoxysilane, zirconium metallates or similar compounds which generally react with water with hydrolysis first to form hydroxides and, after thermal treatment, to form crosslinked, chemically-mechanically stable oxides having good surface adhesion. A multiplicity of commercially available products can be used here. The layer thickness of the coats is from about 100 nm to many microns, depending on use.

### EXAMPLE 9

### Laser Structuring of the Layer

Objects produced according to examples 1 to 6 are produced using a thermally or photochemically crosslinkable coat. Here, either a surface film (2) is applied to the object or one of the thin layers (3) is replaced by the reactive coat. Primarily, coats which can be changed by laser light and nanoparticle precursor coats which are transformed by laser light into dark metallic nanoparticles are suitable here. The object is then provided with a spatially definitively colored inscription with the use of IR radiation by an optical writing system (e.g. laser writer). This process gives rise either to a local change in the refractive index and/or in the layer thickness of the thin layers (3) and/or in the number of nanoparticles on the surface (2) of the material. Analogously, the material can also be optically changed thermally, electrochemically, with microwaves or with electron beams. Said processes lead to a colored inscription of the surfaces. This technology is suitable both for in situ inscription, as a replacement for thermal paper, and also for printing on films and in particular as novel electronic paper (“e-paper”).

### EXAMPLE 10

### Reactive Surface Inscription

Objects produced according to examples 1 to 7 are produced using a thermally or photochemically crosslinkable coat having reactive properties (e.g. water-swellable, temperature-reactive, . . . ). Here, analogously to example 8, either a surface film (2) is applied to the object or one of the thin layers (3) is replaced by the reactive coat. Primarily, UV-crosslinkable hydrogels (polyvinyl-pyrrolidones crosslinked with bisazides) or ionic polymers (polyacrylic acid copolymers, . . . ) or thermally reactive polymers (e.g. poly-N-isopropylacrylamide) polymers are suitable here. The exact reaction conditions are greatly dependent on the material. The object covered with the required layers is then crosslinked in a spatially definitive manner using the radiation of a laser writer. This process leads to a colored inscription of the films with reactive elements which respond to temperature, moisture, pH or other ambient variables in a targeted manner and with spatial resolution.

### EXAMPLE 11

### Mica Pigments

50 g of mica having a particle size of about 10 μm and 0.75 g of carbon black (mean particle size: 15 nm, or another black pigment) are mixed and stirred. The coated mica is suspended in 500 ml of water and, for example, tetraethoxysilane, aluminum tripropoxide, tetraethoxy titanate, tin chloride solution, titanium tetrachloride solution or other film formers are added. In the case of the use of halogen-liberating chemicals, the pH of the solution must be kept constant by addition of bases. After the deposition of the intermediate layer, the particles are filtered off, washed with water and dried.

Nanoparticles or their chemical, laser-convertible precursors are applied to the pigments by coating.

The mica can be replaced by glass lamellae, talc, kaolin or other supports. Fibrous pigments, such as cellulose or polymer fibers, can also be used.

### EXAMPLE 12

### Coating of Reactive Layers for Nanoparticle Production

Pigments having a spacer layer (for establishing the desired hue) are covered with a soluble metal salt or a suspension of very fine particles, preferably having a size of less than 100 nm, from the group consisting of the metals V, Cr, Mn, Fe, Co, Ni, Cu, Ag, Sn, Pb, C, Si, Ge and Bi. The process can be supported by precipitation by means of pH change, solvent change or addition of an anion having precipitating properties.

These particles are either themselves chromophoric or, as a precursor, are preferably converted by means of the laser into oxides or other oxidized compounds, for example phosphates having a chromophoric character.

In order to permit a fast laser writing process, the mean mass thickness should be about 5 nm in the case of metallic particles, and more in the case of chromophoric particles, proportionally to their extinction coefficient.

### EXAMPLE 13

### Top Layer

Particles according to example 12 are mixed with a coating material, preferably a polymer, and applied to the surface of an object. Thereafter, a top layer comprising a further preferably organic polymer (but in the case of outdoor use, also an inorganic, e.g. sol-gel, covering) is generally applied. The layer thickness of the covering is from 0.1 to 100 μm, preferably from 1 to 20 μm. The top layer not only serves for protecting the colored layers but actively absorbs laser energy and passes it on as heat and/or chemical energy and the nanoparticles or precursor layer.

### EXAMPLE 14

### Scattering Top Layer

A structure analogous to example 13 is covered with a top layer comprising a scattering material (generally white is chosen) that becomes transparent after the action of the laser beam because it is briefly melted. Nanoparticles, for example comprising polystyrene or similar polymer, which absorb and pass on the laser energy and then form a protective top film, are preferably used here. The scattering top layer has a thickness of 1-100 μm, preferably 3-20 μm.

The structure according to the invention is illustrated by drawings—natural or artificial structures for color adjustment are characterized by number 6:

FIG. 1: Build-up of the thin layer structure according to claim 1

FIG. 2: Inscription of the thin layer structure by changing the optical density of the top layer (5) by means of a laser or heat

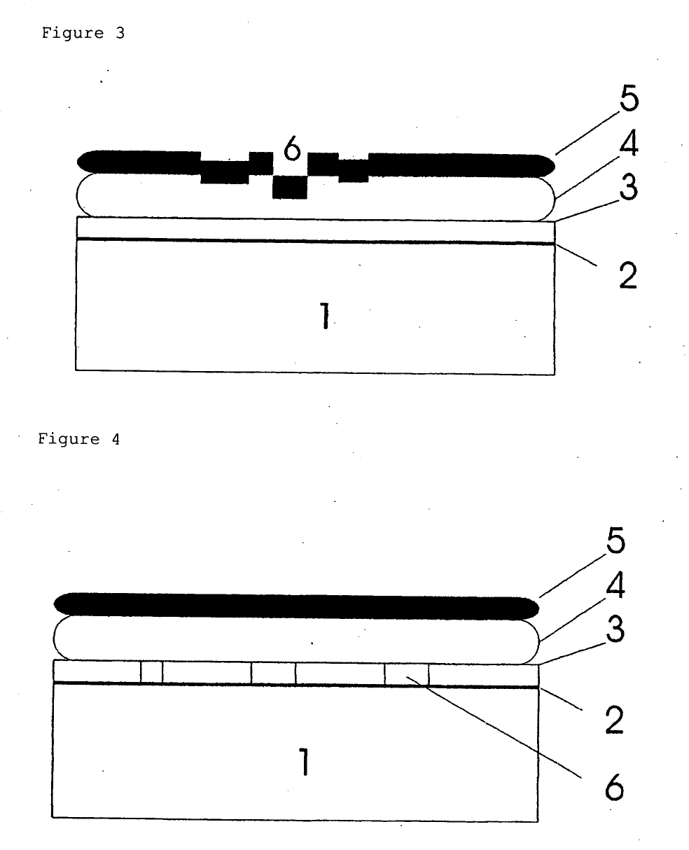

FIG. 3: Inscription of the thin layer structure by changing the optical thickness of the layer (4) by means of a laser or heat

FIG. 4: Inscription of the thin layer structure by changing the optical density of the reflecting layer (3) by means of a laser or heat

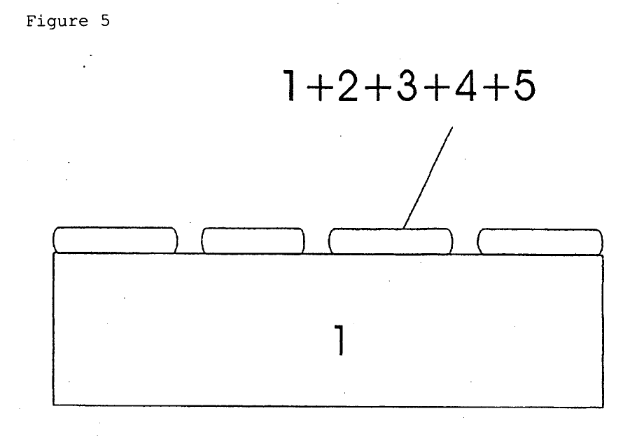

FIG. 5: Build-up of the thin layer structure with intermediate pigment support—the color effect is achieved on the pigment with the same nanometric structure as illustrated in FIG. 1 and the same effects as illustrated in FIGS. 2 to 4.

1) Paper, board, corrugated cardboard, pigment particle, film, injection molded or compression molded plastics part, metal, ceramic surface, paint coat or corrosion protection layer coated with a plurality of thin layers, the material itself or a first layer being a reflective layer which at least partly reflects electromagnetic waves (3) itself or does so at the layer boundary, a second transparent layer (4) being applied above and/or below this reflective layer, and at least one third layer of metallic or strongly chromophoric particles or nanoparticles (5) or the chemical precursors thereof or a thin metallic film being applied on this transparent layer, and the entire structure being able to be changed in its color in a spatially defined and structured manner so as to be detectable to the human eye by the action of light or by direct contact with or close approach to hot objects.

2) The paper, board, corrugated cardboard, pigment particle, film, injection molded or compression molded plastics part, metal, ceramic surface, paint coat or corrosion protection layer as claimed in claim 1 or 2 1, characterized in that the structure is changed in its color in a spatially defined and structured manner so as to be detectable to the human eye by the action of a light source operating in a pixel- or vector-like manner.

3) The paper, board, corrugated cardboard, pigment particle, film, injection molded or compression molded plastics part, metal, ceramic surface, paint coat or corrosion protection layer as claimed in claim 1 or 2 1, characterized in that the structure is changed in its color in a spatially defined and structured manner so as to be detectable to the human eye by laser light, LED light, short arc lamps, flash discharge lamps.

4) The paper, board, corrugated cardboard, pigment particle, film, injection molded or compression molded plastics part, metal, ceramic surface, paint coat or corrosion protection layer as claimed in any of claims 1 to 3, characterized in that the change in the structure which is detectable to the human eye is optionally additionally completed or fixed by thermal or electromagnetic radiation or by mechanical treatment.

5) A method for the production of optically thermally writable materials, such as paper, board, corrugated cardboard, pigment particles, films, injection molded or compression molded plastics parts, metal, ceramic surfaces, paint coats or corrosion protection layers, characterized in that a plurality of thin layers are applied on or in the material (1, 2), the material or a layer being a reflective layer which at least partly reflects electromagnetic waves (3) itself or does so at the layer boundary, a transparent layer (4) being applied above and/or below this reflective layer, and at least one layer of metallic or strongly chromophoric particles or nanoparticles (5) or the chemical precursors thereof or a thin metallic film being applied on this transparent layer.

6) A method for color-imparting inscription of materials, characterized in that a plurality of thin layers are applied on or in the material (1, 2), the material or a layer being a reflective layer which at least partly reflects electromagnetic waves (3) itself or does so at the layer boundary, a transparent layer (4) being applied above and/or below this reflective layer, and at least one layer of metallic or strongly chromophoric particles or nanoparticles (5) or the chemical precursors thereof or a thin metallic film being applied on this transparent layer, and the entire structure being changed in its color in a spatially defined and structured manner so as to be detectable to the human eye by the action of light or by direct contact with or close approach to hot objects.

7) The method as claimed in claim 6, characterized in that any desired characters, character chains, symbols, letters, lines, designs or graphic information (6) become visible as a result of a change in the structure of the thin layers.

8) The method as claimed in either of claims 6 and 7, characterized in that at least a part of the color changes is brought about by a resonance color dependent on the thickness and/or the refractive index of the transparent layer (4) and detectable to the human eye or by means of a detection system.

9) The method as claimed any of claims 6 to 8, characterized in that at least a part of the color changes is brought about by a change in the number and/or the size and/or the shape of the nanoparticles and/or of the reflective layer.

10) The method as claimed in any of claims 6 to 9, characterized in that the color changes take place as a result of generation of chromophoric nanoparticles from colorless and/or slightly colored metal salts by thermal action of the laser.

11) The method as claimed in claim 10, characterized in that the colorless metal salts originate from the group consisting of the metals V, Cr, Mn, Fe, Co, Ni, Cu, Ag, Sn, Pb, C, Si, Ge and Bi.

12) The method as claimed in claim 11, characterized in that metal salts are present as oxalates, carbonates, formates, acetates, hydroxides, phosphates or hypophosphites.

13) The method as claimed in claim 12, characterized in that reducing agents or oxidizing agents which are thermally activatable are added additionally to the metal salts.

14) The method as claimed in claim 13, characterized in that salts of formic acid, oxalic acid, reducing nitrogen-hydrogen compounds, such as hydrazines, or inorganic reducing agents, such as tin(II) salts, hypophosphites, dithionites or borane compounds, are used as reducing agents in order to produce metal nanoparticles or lower oxides.

15) The method as claimed in claim 14, characterized in that peroxides, percarbonates, perborates, nitrates, chlorates, perchlorates or analogous bromine compounds are used as oxidizing agents in order to produce metal oxide nanoparticles.

16) The method as claimed in any of claims 6 to 15, characterized in that the layer reflecting electromagnetic waves has a thickness of <800 nm.

17) The method as claimed in any of claims 6 to 16, characterized in that the transparent intermediate layer consists of a fluoride or a polymer.

18) The method as claimed in claim 17, characterized in that the one porous or foam-like polymeric intermediate layer is changed in its layer thickness by thermal action of the laser, the pores of the intermediate layer being filled with a gas, preferably air.

19) The method as claimed in any of claims 6 to 18, characterized in that a layer having light-scattering properties which masks the color effect and is converted by the laser into a transparent, molten layer is used as a top layer over the nanoparticles or the precursors thereof.

20) The method as claimed in claim 19, characterized in that the light-scattering particles consist of meltable latex, have a back-scattered light color of white or whitish and become transparent by melting of the latex particles to form a layer.

21) The method as claimed in claim 19, characterized in that the light-scattering particles consist of polystyrene, polyvinyl acetate, cellulose esters or ethers, other vinyl polymers, acrylates, methacrylates, polyalkyd resins or the copolymers or mixtures thereof, polystyrene latex being preferably used.

22) The method as claimed in any of claims 6 to 21, characterized in that the transparent layer has a thickness of <700 nm.

23) The method as claimed in any of claims 6 to 22, characterized in that the thin metallic film has a thickness of <100 nm.

24) The method as claimed in any of claims 6 to 23, characterized in that the layer of metallic or strongly chromophoric particles or nanoparticles has a mass thickness of <100 nm.

25) The method as claimed in any of claims 6 to 24, characterized in that the material consists of paper, board, corrugated cardboard, pigment particles, films, injection molded or compression molded plastics parts, metal, ceramic surfaces, paint coats or corrosion protection layers.

26) The method as claimed in any of claims 6 to 25, characterized in that lasers having a power up to 300 watt are used for the spatially defined and structured color change of the coating.

27) The method as claimed in claim 26, characterized in that the laser or lasers is or are a carbon dioxide laser or carbon dioxide lasers without external gas supply or a laser diode or laser diodes.

28) The method as claimed in any of claims 6 to 25, characterized in that lasers having a power greater than 300 watt are used for spatially defined and structured color change of the coating.

29) The method as claimed in any of claims 6 to 28, characterized in that the reflective layer (3) is a metallic layer, the metallic or strongly chromophoric particles (5) of this layer being selected from the group consisting of silver, gold, palladium, platinum, copper, indium, aluminum, nickel, chromium, vanadium, molybdenum, tungsten, titanium, niobium, tantalum, zirconium, tin, germanium, bismuth or silicon, or from another conductive material or the compounds or alloys thereof.

30) The method as claimed in any of claims 6 to 29, characterized in that the metallic or strongly chromophoric particles (5) are formed in particular by reduction of metal compounds from their preferably colorless precursors by thermal conversion or preferably with the aid of laser light, and in particular a mixture consisting at least of a film former, a metal compound and a reducing agent effective at relatively high temperature or in the liquid phase is used for the formation of this layer.

31) The method as claimed in any of claims 6 to 30, characterized in that the number of metallic or strongly chromophoric particles (5) is achieved by the thermal change or dissolution of the metallic particles with the aid of high-energy laser light to give colorless products; preferably by solid and laser-liquefiable acids or alkalis or laser-activatable oxidizing agents in the layer.

32) The method as claimed in any of claims 2 to 31, characterized in that the thickness of the transparent layer (4) is adjusted by thermal change, foaming, crosslinking or thermal collapse, preferably with the aid of a laser or thermally.

33) The method as claimed in claim 32, characterized in that the laser is a gas laser, in particular a carbon dioxide laser or diode laser.

34) The method as claimed in either of claims 6 and 33, characterized in that the absorption of the laser light energy is increased by laser light-absorbing additives in the layer.

35) The method as claimed in claim 34, characterized in that the additives are carboxyl group-containing molecules or metal salts.

36) The method as claimed in any of claims 6 to 35, characterized in that the application of the layers (3, 4, 5) is effected on particles which are then applied to the material by printing, coating or paper technology processes, such as knife coating, spraying, dip coating, or customary printing processes, such as gravure, flexographic, screen, offset or digital printing, curtain coating or roll-coating processes with corotating or counterrotating rolls.

37) The method as claimed in claim 36, characterized in that the particles have a size of not more than three millimeters.

38) The method as claimed in claim 37, characterized in that the particles have a size of from 0.5 to 60 microns.

39) The method as claimed in any of claims 35 to 37, characterized in that the particles are flat metallic particles or inorganic lamellae, such as mica, kaolin, talc, TiO₂ or glass.

40) The method as claimed in any of claims 36 to 39, characterized in that paper, board, corrugated cardboard is used as material and the particles are used by methods of the last paper coating steps, which methods are customary in the paper industry.

41) The method as claimed in any of claims 6 to 40, characterized in that in a surface structuring the coloring is effected by the spatial ordering or reordering of the coated particles or of a part of the particles, in particular by thermal or mechanical change of the layers, preferably embossing.

42) The method as claimed in any of claims 36 to 40, characterized in that the coated particles are bound to the surface of the material by an adhesion agent.

43) The method as claimed in claim 42, characterized in that the adhesion agent is a starch-based adhesive or adhesive based on biologically compatible and/or degradable polymers.

44) A material writable with a laser and produced by a method as claimed in any of claims 6 to 43 or a material as claimed in any of claims 1 to 4, characterized in that the metals or metal salts used can be recovered in a wastewater treatment plant in a recycling process with an efficiency of at least 80%.

45) The material writable with a laser as claimed in claim 44, characterized in that the metals or metal salts used comprise the metals aluminum, titanium, silver, copper, chromium and tin and the salts thereof.
